(19) United States
(12) Patent Application Publication
(10) Pub. No.: US 2018/0173544 A1
(43) Pub. Date: Jun. 21, 2018

(54) INFORMATION PROCESSING DEVICE, INFORMATION PROCESSING METHOD, AND PROGRAM

(71) Applicant: SONY CORPORATION, TOKYO (JP)

(72) Inventors: KATSUYA HYODO, KANAGAWA (JP); KUNIAKI TORII, KANAGAWA (JP); HIKOTATSU CHIN, TOKYO (JP); AKIHIKO IZUMI, KANAGAWA (JP); NAOYUKI SATO, TOKYO (JP)

(73) Assignee: Sony Corporation, Tokyo (JP)

(21) Appl. No.: 15/580,004

(22) PCT Filed: May 25, 2016
(86) PCT No.: PCT/JP2016/065382

§ 371 Date: Dec. 6, 2017

(30) Foreign Application Priority Data
Jun. 30, 2015 (JP) 2015-131905

(51) Int. Cl. G06F 9/451; G06F 3/01; G06F 3/16; G06F 3/0488

(52) U.S. Cl. CPC G06F 9/451; G06F 3/013; G06F 3/016; G06F 3/0488; G06F 3/167

(57) ABSTRACT

[Object] To provide an information processing device, an information processing method, and a program.

[Solution] An information processing device including: an acquiring unit that acquires situation information that is a combination of situation items in a plurality of situation categories; and a specifying unit that perform specification of an input method or an output method of a user interface on a basis of the situation information.

### TECHNICAL FIELD

The present disclosure relates to an information processing device, an information processing method, and a program.

### BACKGROUND ART

An input method and output method (hereinafter, input method and output method may be collectively referred to as input/output method) used by an application in a device are often fixed. For example, with an Internet browser application of a device (e.g., a smartphone) equipped with a touch panel, a touch operation is often used fixedly as the input method and graphical user interface (GUI) display is often used fixedly as the output method. Depending on the application, the input/output method is sometimes able to be manually changed by the user, but this places a large burden on the user.

On the other hand, Patent Literature 1 discloses a rescue system that switches to a voice input mode when a state in which no operation has been input continues for a certain period of time in a manual input mode, taking into consideration the fact that a user may not be able to input information regarding his or her well-being by touching the device during a large-scale disaster.

### CITATION LIST

### Patent Literature

Patent Literature 1: JP 2014-089543A

### DISCLOSURE OF INVENTION

### Technical Problem

However, there is a need for an input method or an output method for a wider variety of situations to be able to be automatically specified and used.

Therefore, the present disclosure proposes an information processing device, an information processing method, and a program which are novel and improved, and which are able to specify an input method or an output method for a wider variety of situations.

### Solution to Problem

According to the present disclosure, there is provided an information processing device including: an acquiring unit that acquires situation information that is a combination of situation items in a plurality of situation categories; and a specifying unit that perform specification of an input method or an output method of a user interface on a basis of the situation information.

In addition, according to the present disclosure, there is provided an information processing method including: acquiring situation information that is a combination of situation items in a plurality of situation categories; and causing a processor to perform specification of an input method or an output method of a user interface on a basis of the situation information.

In addition, according to the present disclosure, there is provided a program for causing a computer to perform: processing of acquiring situation information that is a combination of situation items in a plurality of situation categories; and processing of performing specification of an input method or an output method of a user interface on a basis of the situation information.

### Advantageous Effects of Invention

As described above, according to the present disclosure, it is possible to specify an input method or an output method for a wider variety of situations.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an outline of a wearable device according to an embodiment of the present disclosure.

FIG. 2 is an explanatory diagram illustrating a configuration example of the wearable device according to the embodiment

FIG. 3 is a flowchart illustrating an operation flow of the wearable device according to the embodiment.

FIG. 4 is an explanatory diagram illustrating an example of evaluation values that an input/output method specifying unit according to the embodiment uses to specify an input/output method.

FIG. 5 is an explanatory diagram illustrating an example in which the input/output method is specified by the input/output method specifying unit according to the embodiment

FIG. 6 is an explanatory diagram for describing a modified example of the embodiment.

FIG. 7 is an explanatory diagram illustrating a hardware configuration example of the wearable device according to the embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that the description will be given in the following order.

«1. Outline»

«2. BACKGROUND»

«3. Configuration»

«4. Operation»
<4-1. Operation flow>
<4-2. Specific examples>

«5. Modified example»

«6. Hardware configuration example»

«7. Conclusion»

### 1. OUTLINE

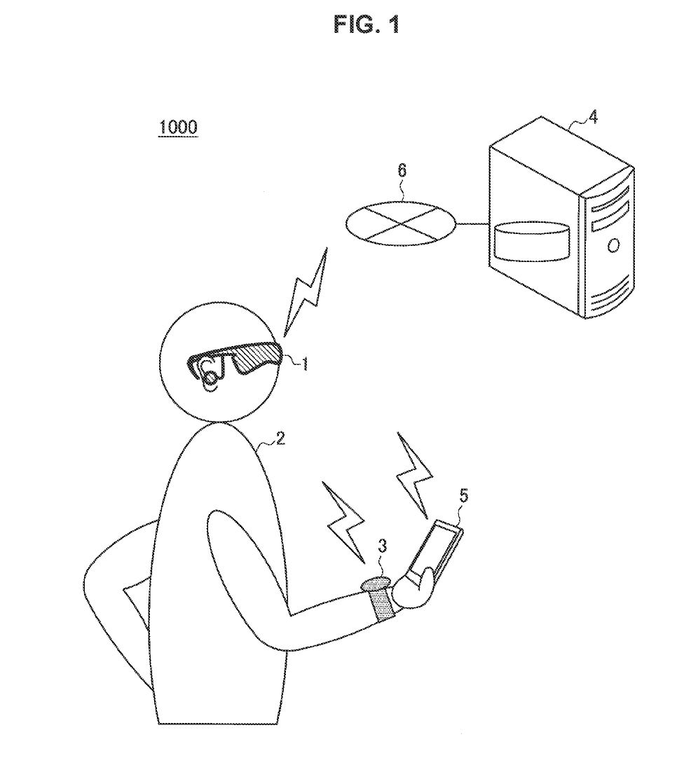

First, an outline of an embodiment of the present disclosure will be described with reference to the drawings. FIG. 1 is an explanatory diagram illustrating the configuration of an information system that includes a wearable device according to an embodiment of the present disclosure.

An information system 1000 according to an embodiment of the present disclosure includes a wearable device 1, a sensor device 3, a server 4, a touch device 5, and a communication network 6, as illustrated in FIG. 1. The information system 1000 automatically selects the input/output method of the wearable device 1 on the basis of situation information relating to a user 2, the environment around the user 2 and the like.

The wearable device 1 acquires situation information relating to the user 2, the environment around the user 2 and the like by analyzing various kinds of data received from the server 4, sensing data received from the sensor device 3, sensing data obtained by sensing of the wearable device 1, and the like. The wearable device 1 also specifies the input/output method (the input method and the output method) of the user interface of the wearable device 1 on the basis of the acquired situation information, and changes the input/output method. The input method according to the present embodiment may be input by touch (a touch operation), voice, gaze, or the like, for example. Also, the output method according to the present embodiment may be output by GUI display, voice (speaker, earphones or the like), vibration, light emitting diode (LED) light (hereinafter, also simply referred to as LED), or the like. Also, the input/output method according to the present embodiment may be a method by which input/output is performed via an input unit or an output unit included in the wearable device 1, or a method by which input/output is performed via an input unit or an output unit included in the touch device 5 that is connected to the wearable device 1. Further, the input/output method according to the present embodiment may be a method by which input/output is performed by another input device or output device that is not illustrated. Note that the wearable device 1 may be an eyeglasses-type information processing device worn by the user 2, as illustrated in FIG. 1.

The sensor device 3 senses information about the user 2, the environment around the user 2 and the like, and transmits the obtained data (sensing data) to the wearable device 1. The sensor device 3 may be directly connected to the wearable device 1 via wireless communication such as Bluetooth (registered trademark), wireless LAN, or Wi-Fi, or may be connected to the wearable device 1 via the communication network 6. Also, the sensor device 3 may be a sensing device that includes sensors such as a global positioning system (GPS) sensor, an acceleration sensor, a gyro sensor, a heart rate sensor, and an illuminance sensor. Note that the sensors included in the sensor device 3 are not limited to the sensors described above. The sensor device 3 may also include a temperature sensor, a magnetic sensor, a camera, a microphone and the like. Also, FIG. 1 illustrates an example in which the sensor device 3 is a sensing device that is worn on a hand (arm) of the user 2, but the present technology is not limited to this example. For example, the sensor device 3 may be a sensing device that is worn on a part of the user 2 other than a hand, such as the neck, or may be a sensing device such as a camera or a microphone that is arranged in a home or around a city.

The server 4 is an information processing device that transmits various kinds of data such as map data, route data, or various kinds of statistical data, in addition to personal data relating to the user 2, to the wearable device 1. For example, the personal data may be information relating to the user 2 or information managed by the user 2, such as a calendar (schedule), mail, a TO DO list, social networking service (SNS), and website browsing history. Also, the server 4 may be connected to the wearable device 1 via the communication network 6.

The touch device 5 is a device that is connected to the wearable device 1, and through which input or output in an application of the wearable device 1 is performed. For example, the touch device 5 may be a device such as a smartphone or a tablet PC that includes a touch panel as an input unit and an output unit, and that enables input by touch and output by GUI display. The touch device 5 may also be a device that includes a vibration device and an LED as output units, and which enables output by vibration or LED light emission. Note that the touch device 5 may be directly connected to the wearable device 1 via wireless communication such as Bluetooth (registered trademark), wireless LAN, or Wi-Fi, or may be connected to the wearable device 1 via the communication network 6.

The communication network 6 is a wired or wireless transmission path for information transmitted from devices connected to the communication network 6. For example, the communication network 6 may include a public network such as the Internet, a telephone network, and a satellite communication network, and various types of area networks such as a local area network (LAN) and a wide area network (WAN) including Ethernet (registered trademark). Also, the communication network 6 may also include a leased line network such as an Internet protocol-virtual private network (IP-VPN).

### 2. BACKGROUND

The outline of the information system 1000 that includes the wearable device 1 according to an embodiment of the present disclosure has been described above. Continuing on, the background that led to the creation of the wearable device 1 according to the present embodiment will be described.

The input/output method used by an application in a device (information processing device) such as the wearable device 1 and the touch device 5 is often fixed. For example, with an Internet browser application of a device equipped with a touch panel, such as a smartphone, a touch operation is often used fixedly as the input method and graphical user interface (GUI) display is often used fixedly as the output method.

However, in a situation where a user is unable to use the input/output method or where using the input/output method is difficult, in a case where the input/output method is fixed, there are cases where the application is unable to be used, or the operability, browsability or the like of the application is diminished. Hereinafter, a restriction in which the input/output method is unable to be used or is difficult to use, as described above, may be referred to as an input/output restriction.

For example, in a case where the user uses a smartphone and browses a recipe site while cooking, water, cooking ingredients and the like adhere to the user's fingertips, which makes an operation by touch input in which the user directly touches the smartphone difficult. Also, there are cases where browsability of the output method by GUI display using sight is diminished because the user is using his or her sight to cook.

With respect to the above situation, there are cases where, depending on the application, the user is able to manually change the input/output method, but performing an operation to change the input/output method each time the activity of the user, the environment around the user or the like changes is quite a burden for the user.

Also, although it is possible to simultaneously activate a plurality of input/output methods that are usable with the device, doing so ends up increasing power consumption. Moreover, there are cases where, if an input/output method that is not preferable in the situation is activated, the user ends up performing an unintentional input, or output that impedes the activity of the user ends up being performed. For example, if voice input is activated in a case where the environment around the user is noisy, input different from the intentions of the user is likely to be performed. Also, if voice output from a speaker is performed while the user is listening to music, for example, it may interrupt the user's listening to the music.

Also, it is possible to have the mode switch from a manual input mode to a voice input mode (hereinafter, such technology may be referred to as related technology) in a case where a state in which no operation has been input continues for a certain period of time in the manual input mode. However, with this related technology, if the mode ends up switching from the manual input mode to the voice input mode, the user may end up not being able to perform an operation other than voice input, even if the user is able to perform input manually. Also, with the related art described above, only the passage of time is used as the trigger for switching the input method, so there are cases where it is not possible to deal with an input/output restriction that is created or changed for a wide variety of situations such as the activity of the user or the environment around the user. Moreover, the related technology described above is technology that is limited to only switching from the manual input mode to the voice input mode, so there is a need for technology that is compatible with a wide variety of input methods or output methods.

Therefore, the present embodiment was created with the above situation in mind. According to the present embodiment, it is possible to change to a suitable input/output method as needed for a wide variety of situations. The present embodiment is also compatible with a wide variety of input methods or output methods, which makes it possible to deal with a wide range of input/output restrictions. The configuration of the present embodiment having such an effect will be described in detail below.

### 3. CONFIGURATION

Above, the background that led to the creation of the wearable device 1 according to the present embodiment is described. Continuing on, the configuration of the wearable device 1 according to the present embodiment will be described.

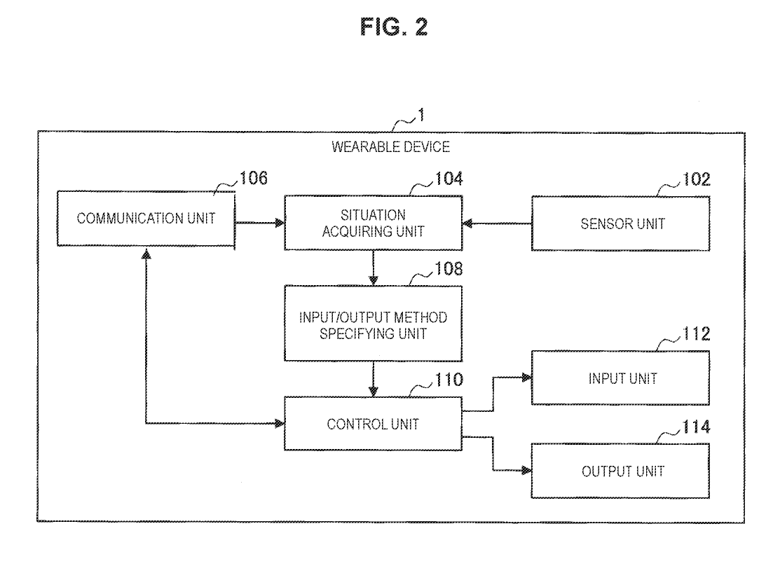

FIG. 2 is an explanatory diagram illustrating a configuration example of the wearable device 1. As illustrated in FIG. 2, the wearable device 1 is an information processing device that includes a sensor unit 102, a situation acquiring unit 104 (acquiring unit), a communication unit 106, an input/output method specifying unit 108 (specifying unit), a control unit 110, an input unit 112, and an output unit 114.

### (Sensor Unit)

The sensor unit 102 senses information about the user 2, the environment around the user 2 and the like, and provides the acquired sensing data to the situation acquiring unit 104. The sensor unit 102 may include sensors such as a microphone, a camera, a global positioning system (GPS) sensor, an acceleration sensor, a gyro sensor, a heart rate sensor, and an illuminance sensor. Note that the sensors included in the sensor unit 102 are not limited to the sensors described above. The sensor unit 102 may also include a temperature sensor, a magnetic sensor, a gaze detection sensor and the like.

### (Situation Acquiring Unit)

The situation acquiring unit 104 (acquiring unit) acquires situation information by analyzing various kinds of data received from the sensor unit 102 and the communication unit 106 that will be described later. The situation information acquired by the situation acquiring unit 104 may be a combination of situation items in a plurality of situation categories, for example. The situation categories may include user activity, environment, user restriction, and device restriction, for example. User activity may be, for example, a category that includes information relating to an activity performed by the user 2. Also, environment may be a category that includes information relating to the environment around the user 2. Further, user restriction may be a category that includes information relating to an input/output method that the user 2 is unable to use. Also, device restriction may be a category that includes information relating to a restriction that depends on the device (e.g., the wearable device 1 in the present embodiment). For example, device restriction may include information indicating that voice input is unable to be used due to a microphone malfunction, or that there is an input/output method that is unable to be used because it is being used by another application or the like.

Also, the situation item may be an item indicating a typical situation (state) in a situation category that includes the situation item. For example, the user activity situation category may include situation items such as cooking, driving, eating, riding on a train, swinging a golf club, watching a soccer match, conversing, listening to music, walking, running, and sleeping. Also, the situation items in the environment situation category may include items such as outdoors, indoors (home), indoors (workplace), indoors (other), noisy, quiet, bright, and dark. Also, the situation items in the user restriction situation category may include items such as unable to use hands, unable to use voice, unable to use sound, and unable to use gaze (unable to look). Also, the situation items in the device restriction situation category may include items such as unable to use earphones and unable to use speaker.

Also, the situation acquiring unit 104 may generate (acquire) situation information by analyzing the sensing data acquired by the sensor unit 102 and the sensor device 3 described with reference to FIG. 1, personal data of the user 2 transmitted from the server 4 described with reference to FIG. 1, and the like. The sensing data acquired by the sensor unit 102 and the sensor device 3 may include information such as acceleration data, GPS data, heart rate data, voice data, image data, and illuminance data, in the past and present, acquired by the respective sensors described above, for example.

For example, the user activity situation items may be acquired by analyzing sensing data, personal data, current time, map data, route data, and various kinds of statistical data. For example, acceleration data, GPS data, map data, and route data are useful for recognizing user activities related to movement of the user 2, such as walking, running, driving, and riding on a train. Also, heart rate data is useful for recognizing whether the user 2 is sleeping. Further, voice data and image data are useful for recognizing user activities such as cooking, swinging a golf club, watching a soccer match, conversing, and listening to music.

Also, the environment situation item may also be acquired by analyzing sensing data, personal data, current time, map data, route data, and various kinds of statistical data. For example, data such as GPS data, personal data (home and company location information and the like), and map data are useful for recognizing the environment relating to locations such as outdoors, indoors (home), indoors (workplace), and indoors (other). Further, outdoors and indoors may be distinguished on the basis of the accuracy of GPS data and a favorable/unfavorable wireless communication environment. Also, voice data is useful for recognizing the environment relating to noise such as noisy or quiet. Also, illuminance data is useful for recognizing the environment relating to brightness such as bright or dark.

Also, pattern recognition technology using various kinds of data as input, for example, may be used to analyze the data described above. For example, according to pattern recognition technology, in a case where data similar to previously learned data is input, the learning data situation item can be specified as an input data information item.

Also, the situation acquiring unit 104 may acquire situation information on the basis of a setting operation by the user 2 and system information relating to the wearable device 1. For example, the user restriction situation items may be set in advance by the user 2 in a case where there is a restriction on touch operations, speech, eye movement or the like due to the user 2 having a disability, or the like. Also, the device restriction situation items may be set on the basis of system information such as failure information or the like of the input unit 112 or the output unit 114.

Note that if the situation information acquired by the situation acquiring unit 104 is a combination of situation items in a plurality of situation categories, the situation information may be a combination that includes a plurality of situation items belonging to one situation category, or a combination that includes one situation item belonging to each situation category.

### (Communication Unit)

The communication unit 106 is a communication interface that mediates communication by the wearable device 1. The communication unit 106 supports an arbitrary wireless communication protocol or wired communication protocol, and establishes a communication connection with the server 4 via the communication network 6 described with reference to FIG. 1, for example. Therefore, the wearable device 1 is able to receive various kinds of data from the server 4. Also, the communication unit 106 establishes a communication connection with the sensor device 3, and is able to receive sensing data from the sensor device 3. Further, the communication unit 106 establishes a communication connection with the touch device 5 described with reference to FIG. 1, and enables an application of the wearable device 1 to use an input/output method using the input unit and the output unit of the touch device 5. Also, the communication unit 106 provides the data received from the server 4 and the sensor device 3 to the situation acquiring unit 104.

### (Input/Output Method Specifying Unit)

The input/output method specifying unit 108 (specifying unit) performs specification of the input method and the output method (input/output method) of the user interface on the basis of the situation information acquired by the situation acquiring unit 104, and provides information indicating the specified input/output method to the control unit 110. For example, the input/output method specifying unit 108 may perform the specification on the basis of situation information (a combination of situation items in a plurality of situation categories), and an evaluation value of each input method or each output method set in advance for each situation item. According to this configuration, it is possible to change to a suitable input/output method as needed for a wide variety of situations covered by the combination of situation items in a plurality of situation categories. Also, in a case where a new input/output method is able to be used, it is possible to accommodate the input/output method, without changing the method for specifying the input/output method, by setting the evaluation value of the input/output method. Therefore, the present technology is able to accommodate a wide variety of input/output methods.

For example, the evaluation value described above may be set such that an evaluation value of a more preferable input method or output method becomes smaller, for the situation item related to the evaluation value. Also, in this case, the input/output method specifying unit 108 may perform specification of the output/input method by specifying the input method or the output method with the smallest total evaluation value obtained by adding up the evaluation values for the situation information. Here, the situation information is a combination of situation items, so, for example, the input/output method specifying unit 108 may calculate the total evaluation value for each input/output method by adding up the evaluation values corresponding to a plurality of situation items included in the situation information, and specify the input method and the output method with the smallest total evaluation values. According to this configuration, there is an effect in which it is possible to specify a more preferable input/output method in accordance with the situation information.

Also, in a case where an input/output method related to the evaluation value, in a situation item related to the evaluation value, is unable to be used, a value indicating that the input/output method is unusable may be set as the evaluation value. Also, in this case, the input/output method specifying unit 108 may perform the specification such that an unusable input/output method will not be used. For example, the input/output method specifying unit 108 may exclude, from the input/output method to be specified, an input/output method in which even one value indicating that the input/output method is unusable, in the plurality of situation items included in the situation information, is set. According to this configuration, it is possible to perform specification of an input/output method in accordance with the situation such that an unavailable input/output method in the situation will not be used.

Also, the input/output method specifying unit 108 may perform the specification in a case where there is a change (difference) in the situation information acquired by the situation acquiring unit 104, and not perform the specification in a case where there is no change in the situation information. In this case, for example, the input/output method specifying unit 108 that has received situation information may determine whether there is a change in the situation information, and the situation information may be provided from the situation acquiring unit 104 to the input/output method specifying unit 108 only in a case where there is a change in the situation information. In a case where the situation information is the same (where there is no change in the situation information), the input/output method specified by the input/output method specifying unit 108 is also the same, so a specifying process is unnecessary. Therefore, according to this configuration, the amount of processing is able to be reduced.

Also, in a case where a change in the situation information is drastic, the input/output method specified by the input/output method specifying unit 108, and the input/output method able to be used by the user, end up changing drastically, and the operation and the like may end up becoming difficult for the user. Therefore, the input/output method specifying unit 108 may perform the specification in a case where the situation information acquired by the situation acquiring unit 104 is maintained for a predetermined period of time (a predetermined number of times). In this case, for example, whether the situation information has been maintained for a predetermined period of time may be determined by the input/output method specifying unit 108 that has received the situation information, and the situation information may be provided from the situation acquiring unit 104 to the input/output method specifying unit 108 only in a case where the situation information has been maintained for a predetermined period of time. According to this configuration, a change in the input/output method is able to be suppressed even in a case where the situation information has changed drastically.

Note that the input/output method specifying unit 108 may specify the most preferable input method and output method (with the smallest total evaluation value), or may prioritize the input method(s) and/or output method(s) to specify one or a plurality of input methods or output methods that can be used.

### (Control Unit)

The control unit 110 controls the respective units in the wearable device 1. In particular, the control unit 110 controls the input method and output method of the user interface of various applications and the like of the wearable device 1, in accordance with the information of the input/output method received from the input/output method specifying unit 108. For example, the control unit 110 changes the input/output method by controlling and activating or deactivating the input unit 112 and the output unit 114, in accordance with the input/output method specified by the input/output method specifying unit 108. The control unit 110 may also control an external device (not illustrated), other than the wearable device 1, which has an input function or an output function, via the communication unit 106, and use the external device as a user interface (input source, output destination) of the wearable device 1, as necessary. Examples of such an external device as described above include the touch device 5 described with reference to FIG. 1, a speaker having a communication function and the like.

Note that the input method and the output method that can be supported by each application may be set in advance, and the control unit 110 may perform control such that an input/output method with a higher priority, among the input/output methods that can be supported by the application, is used. The control unit 110 may also deactivate input or output of an application, in a case where there is no input method or output method that can be used in the current situation, from among input/output methods that can be supported by the application.

Also, in a case of an input/output method that is not supported by an application but that can be converted by the control unit 110, the input/output method may be used by the control unit 110 performing the conversion. For example, even with an application that does not support voice output, voice output may be used by the control unit 110 converting text to voice using text to speech (TTS) technology. Also, even with an application that does not support gaze input, gaze input may be used by the control unit 110 converting gaze coordinate information to input coordinate information for a touch panel or the like.

The control unit 110 also determines whether the wearable device 1 is being used. For example, the control unit 110 may determine that the wearable device 1 is not being used in a case where it has not been operated at all for a predetermined period of time. The control unit 110 may also determine whether the wearable device 1 is being worn by the user, by the sensing data acquired from the sensor unit 102 and the like, and may determine that the wearable device 1 is being used in a case where the wearable device 1 is being worn by the user.

### (Input Unit)

The input unit 112 is inputting means for operating the wearable device 1 by the user inputting information, such as a microphone, a gaze sensor (gaze input device), or a gesture recognition camera. The input unit 112 is activated or deactivated under the control of the control unit 110.

### (Output Unit)

The output unit 114 is outputting means for an application of the wearable device 1 to output information, such as a display, an LED light, earphones, a speaker, or a vibration device. For example, the display is capable of GUI display, the LED light is capable of notification via LED light illumination, the earphones and speaker are capable of voice output, and the vibration device is capable of notification via vibration. The output unit 114 is activated or deactivated under the control of the control unit 110.

### 4. OPERATION

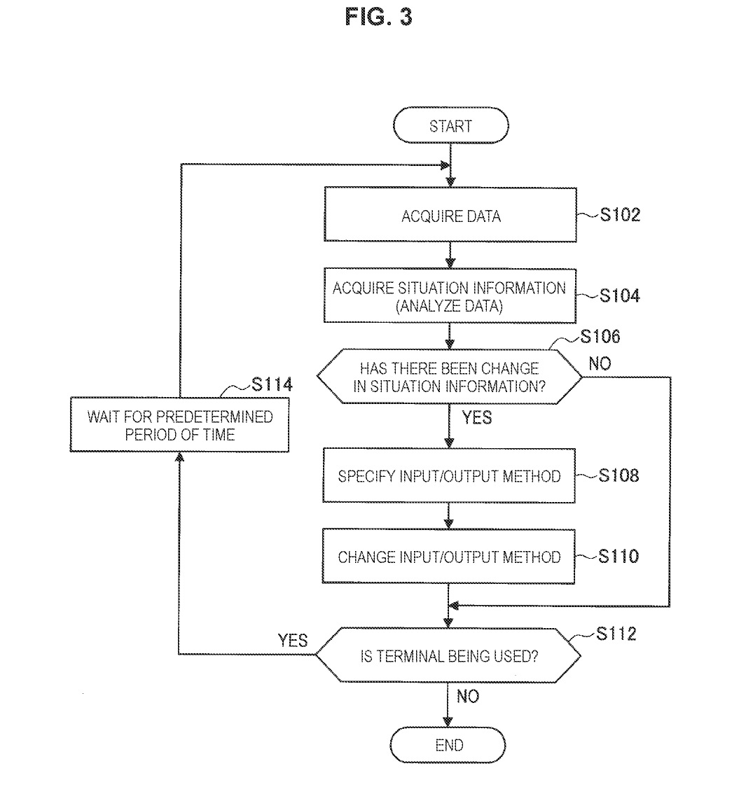

Heretofore, a configuration example of the wearable device 1 according to an embodiment of the present disclosure is described. Continuing on, an operation example of the wearable device 1 according to an embodiment of the present disclosure will be described with reference to FIGS. 3 to 5. Hereinafter, the operation flow of the present embodiment will be described, and then specific examples (specific use cases) of operation in the present embodiment will be described.

### 4-1. Operation Flow

FIG. 3 is a flowchart illustrating the operation flow of the wearable device 1 according to the embodiment.

First, various kinds of data for obtaining situation information is acquired by sensing via the sensor unit 102 and receiving various kinds of data via the communication unit 106 (S102). Then, the situation acquiring unit 104 acquires situation information by analyzing the various kinds of data (S104).

In a case where the situation information acquired by the situation acquiring unit 104 is the same as the situation information acquired most recently (there has not been any change) (NO in S106), the process proceeds on to step S112 that will be described later.

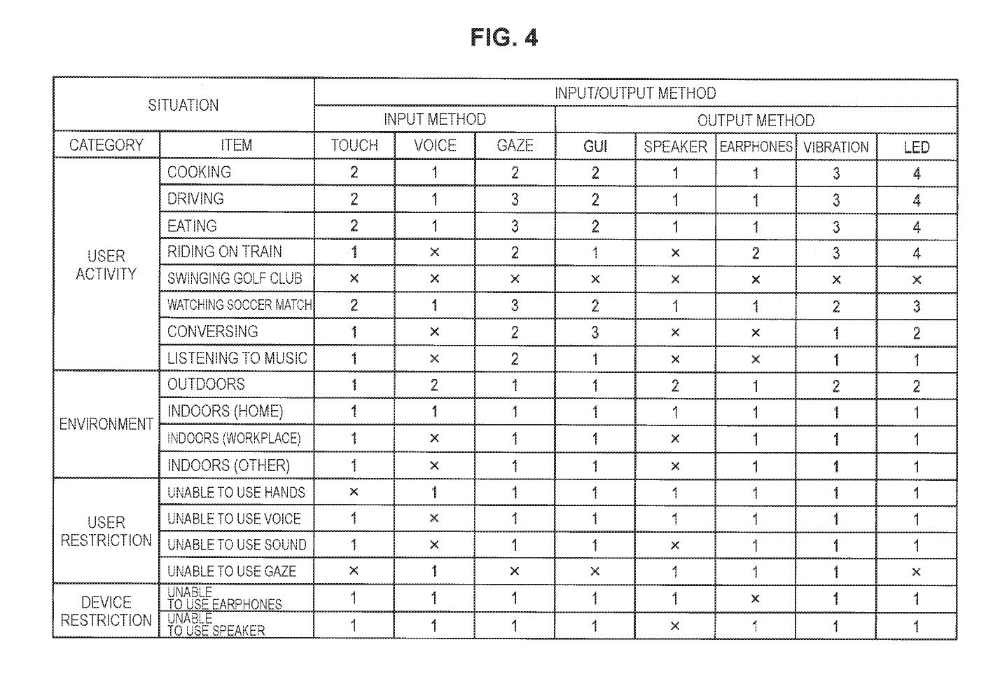

On the other hand, in a case where the situation information acquired by the situation acquiring unit 104 differs from the situation information acquired most recently (there has been a change) (YES in S106), the input/output method specifying unit 108 performs specification of an input/output method. FIG. 4 is an explanatory diagram illustrating an example of evaluation values that the input/output method specifying unit 108 uses to specify input/output method.

As illustrated in FIG. 4, an evaluation value is set for each situation item and each input/output method. Note that “X” illustrated in FIG. 4 is a value indicating that the input/output method is unable to be used in the situation item. For example, the input/output method specifying unit 108 may calculate the total evaluation value for each input/output method by adding up the evaluation values corresponding to a plurality of situation items included in the situation information acquired by the situation acquiring unit 104. Then, the input/output method specifying unit 108 specifies both the input method and the output method such that the input/output method with the smaller total evaluation value is used preferentially. Note that specification is performed such that an input/output method with even one “X” in a situation item included in the situation information will not be used, regardless of the evaluation values of the other situation items.

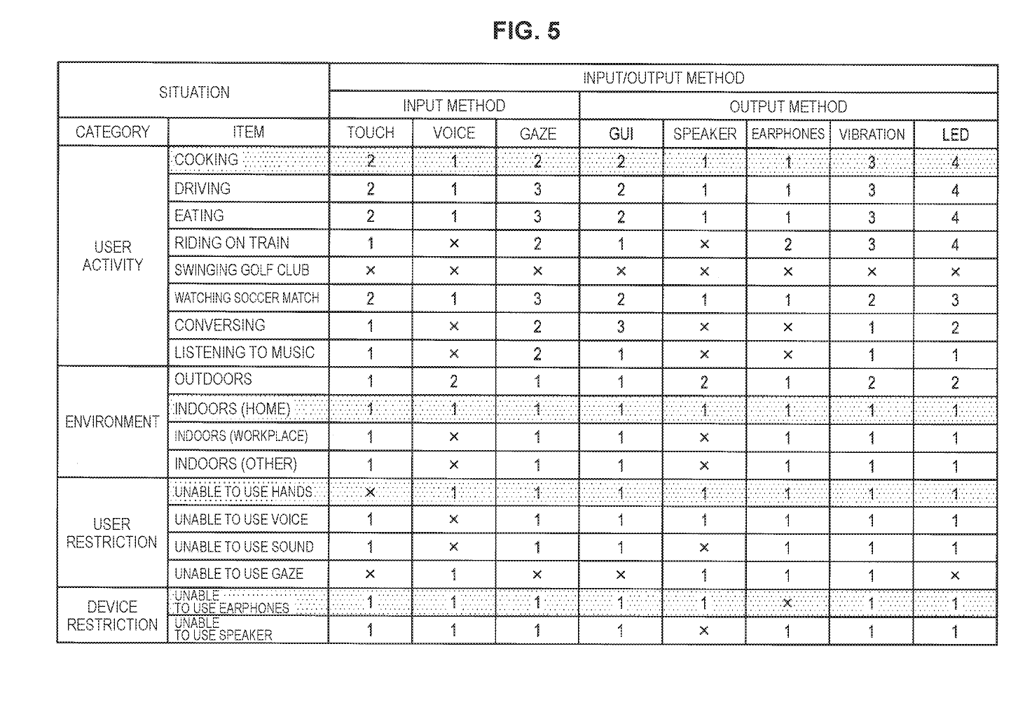

For example, the input/output method specifying unit 108 specifies the input/output method as described below in step S108. FIG. 5 is an explanatory diagram illustrating an example in which an input/output method is specified by the input/output method specifying unit 108 in a case where a combination (situation information) of situation items that are “cooking,” “indoors (home)”, “unable to use hands,” and “unable to use earphones” has been acquired by the situation acquiring unit 104.

First, the input/output method specifying unit 108 calculates the total evaluation values for the input methods and performs specification of the input method. Because “touch” includes an evaluation value of “X” in the user restriction as illustrated in FIG. 5, “touch” will not be used, regardless of the evaluation values of the other situation items. Also, the total evaluation value for “voice” is 1+1+1+1=4, from FIG. 5. Also, the total evaluation value for “gaze” is 2+1+1+1=5, from FIG. 5. Thus, for the input method, “voice” is given the highest priority, “gaze” is given the next highest priority, and “touch” is specified as being unable to be used.

Continuing on, the input/output method specifying unit 108 calculates the total evaluation values for the output methods and performs the specification of the output method. The total evaluation value for “GUI” (GUI display) is 2+1+1+1=5, from FIG. 5. Also, the total evaluation value for “speaker” is 1+1+1+1=4, from FIG. 5. Also, because “earphones” includes an evaluation value of “X” in the device restriction as illustrated in FIG. 5, “earphones” will not be used, regardless of the evaluation values of the other situation items. Also, the total evaluation value for “vibration” is 3+1+1+1=6, from FIG. 5. Also, the total evaluation value for “LED” (LED light) is 4+1+1+1=6, from FIG. 5. Thus, for the output method, priority is given to “speaker,” “GUI,” “vibration,” and “LED” in that order, and “earphones” is specified as being unable to be used.

Returning to the description of the operation flow illustrated in FIG. 3, the control unit 110 that has received the information indicating the input/output method specified by the input/output method specifying unit 108 then controls the input unit 112 and the output unit 114, or an external device other than the wearable device 1, and changes the output/input method (S110 illustrated in FIG. 3).

Continuing on, the control unit 110 determines whether the wearable device 1 (terminal) is being used (S112). In a case where the wearable device 1 (terminal) is not being used (NO in S112), the process ends. On the other hand, in a case where the wearable device 1 (terminal) is being used (YES in S112), the process waits for a predetermined period of time (S114), and then returns to step S102 and the process described above is repeated.

### 4-2. Specific Examples

Above, the operation flow of the wearable device 1 according to the present embodiment has been described. Next, several specific use cases (specific examples) realized by the operation flow described above will be described.

### Specific Example 1

An example of a case where the user is driving will be described as specific example 1. In this case, the situation acquiring unit 104 acquires situation information that is “driving,” “outdoors,” and “unable to use earphones,” for example, on the basis of GPS data, acceleration data and the like. In FIG. 4, when calculating the total evaluation values by adding up the evaluation values of the situation items described above for each input/output method, and performing specification of an input/output method, the input method with the highest priority is voice input, and the output method with the highest priority is voice output (speaker).

For example, in a case where a map is searched in a map application, the input method will be touch input and the output method will be GUI display at any time other than while driving, but when driving starts (when “driving” becomes included in the situation information), the input/output method is changed to input/output via voice. Note that in a case where the control unit 110 can detect and control a device of an occupant other than the driver, and the occupant is able to operate the device, the control unit 110 may control the device such that touch input and GUI display are performed by the device.

### Specific Example 2

An example of a case where the user is eating will be described as specific example 2. In this case, the situation acquiring unit 104 acquires situation information that is “eating” and “indoors (other),” for example, on the basis of GPS data, acceleration data, voice data, image data and the like. In FIG. 4, when calculating the total evaluation values by adding up the evaluation values of the situation items described above for each input/output method, and performing specification of an input/output method, the input method with the highest priority is voice input, and the output method with the highest priority is voice output (earphones).

For example, it is assumed that when a user views the news using a browser application before eating, the input method of the wearable device 1 is touch input and the output method is GUI display. Here, when the user starts to eat (when “driving” becomes included in the situation information), the input/output method is changed to input/output via voice.

### Specific Example 3

An example of a case where the user is riding on a train will be described as specific example 3. In this case, the situation acquiring unit 104 acquires situation information that is “riding on a train” and “outdoors,” for example, on the basis of GPS data, acceleration data and the like. In FIG. 4, when calculating the total evaluation values by adding up the evaluation values of the situation items described above for each input/output method, and performing specification of an input/output method, the input method with the highest priority is touch input, and the output method with the highest priority is GUI display output.

For example, in a case where a user is using a train route (transfer) guide application by voice input/output prior to boarding a train, the input/output method is changed to touch input and GUI display output when the user boards a train (when “riding on a train” becomes included in the situation information).

### Specific Example 4

An example of a case where the user is watching a soccer match will be described as specific example 4. In this case, the situation acquiring unit 104 acquires situation information that is “watching a soccer match” and “outdoors,” for example, on the basis of personal data (schedule, etc.), GPS data, acceleration data and the like. In FIG. 4, when calculating the total evaluation values by adding up the evaluation values of the situation items described above for each input/output method, and performing specification of an input/output method, the input method with the highest priority is voice input, and the output method with the highest priority is voice output (earphones).

For example, in a case where a user is using an SNS browsing application via touch input and GUI display output to view posts related to a soccer match before the match starts, the input/output method changes to input/output via voice when the match starts.

### Specific Example 5

An example of a case where the user is swinging a golf club will be described as specific example 5. In this case, the situation acquiring unit 104 acquires situation information that is “swinging a golf club” and “outdoors,” for example, on the basis of GPS data, acceleration data, image data and the like. In this case, referring to FIG. 4, none of the input/output methods are able to be used.

For example, even if a user receives mail while swinging a golf club, the user will not be notified by any output method while swinging the golf club. The user will be notified via voice output (earphones) after swinging the golf club (when “swinging a golf club” is no longer included in the situation information).

### Specific Example 6

An example of a case where the user is conversing will be described as specific example 6. In this case, the situation acquiring unit 104 acquires situation information that is “conversing” and “indoors (workplace),” for example, on the basis of GPS data, voice data, image data and the like. In FIG. 4, when calculating the total evaluation values by adding up the evaluation values of the situation items described above for each input/output method, and performing specification of an input/output method, the input method with the highest priority is touch input, and the output method with the highest priority is vibration output.

For example, in a case where a user receives mail while conversing with a superior, the user is notified by vibration output during the conversation, and the user can then check the content of the mail by touch input and GUI display output after the conversation has ended (when “conversing” is no longer included in the situation information).

### Specific Example 7

An example of a case where the user is listening to music will be described as specific example 7. In this case, the situation acquiring unit 104 acquires situation information that is “listening to music” and “indoors (home),” for example, on the basis of GPS data, voice data, personal data and the like. In FIG. 4, when calculating the total evaluation values by adding up the evaluation values of the situation items described above for each input/output method, and performing specification of an input/output method, the input method with the highest priority is touch input, and the output method with the highest priority is output by any one of GUI display, vibration, and LED.

For example, in a case where a user receives a message in an SNS browsing application while listening to music, the user is notified by vibration, LED light or the like, but is not notified by sound.

### 5. MODIFIED EXAMPLE

Heretofore, an embodiment of the present disclosure has been described. A modified example of the present embodiment will be described below. Note that the modified example described below may be applied instead of the configuration described in the present embodiment, or in addition to the configuration described in the present embodiment.

In the description above, an example has been described in which the evaluation values for specifying the input/output method are set such that the evaluation value of a more preferable input/output method is smaller, in the situation items related to the evaluation values, but the present technology is not limited to this example. For example, the evaluation values for specifying the input/output method may also be set to one of a value indicating that the input/output method related to the evaluation value is able to be used, and a value indicating that the input/output method related to the evaluation value is unable to be used.

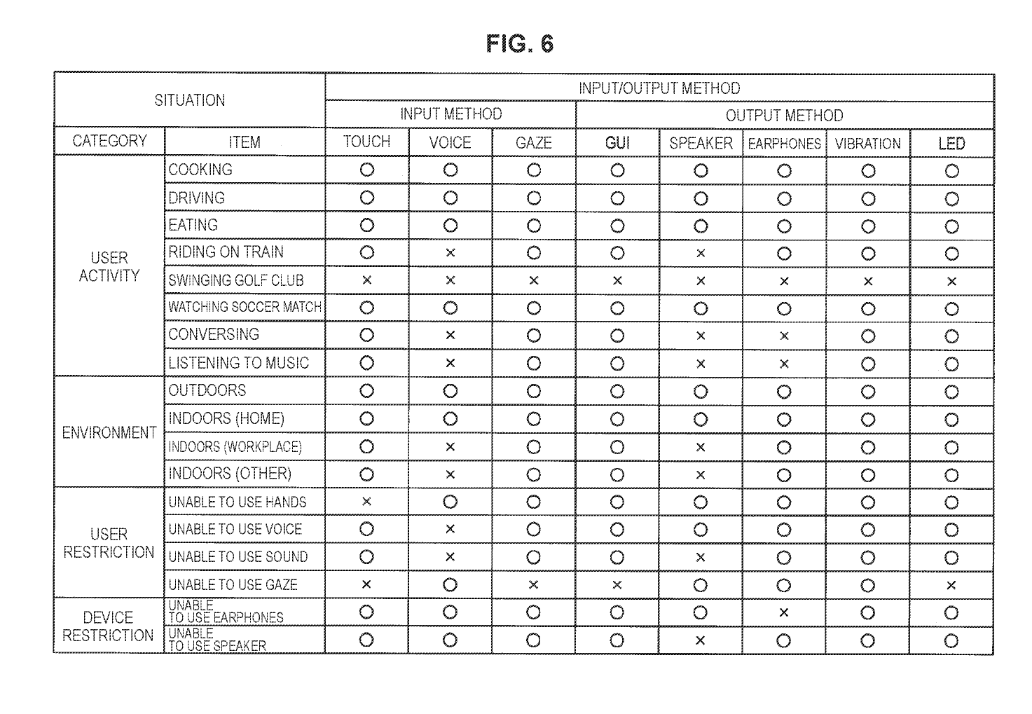

FIG. 6 is an explanatory diagram for describing evaluation values set to one of a value indicating that the input/output method related to the evaluation value is able to be used, and a value indicating that the input/output method related to the evaluation value is unable to be used. “O” illustrated in FIG. 6 is a value indicating that the input/output method is able to be used in the situation item, and “X” is a value indicating that the input/output method is unable to be used in the situation item.

In a case where the evaluation values are set as described above, the input/output method specifying unit 108 may specify a usable input/output method on the basis of the evaluation values and the situation information illustrated in FIG. 6. According to this configuration, it is possible to perform specification of an input/output method in accordance with the situation such that only an input/output method that is able to be used in the situation will be used.

### 6. HARDWARE CONFIGURATION EXAMPLE

Heretofore, an embodiment and each modified example of the present disclosure have been described. Information processing such as the situation acquisition processing, the input/output method specifying processing, and the control processing described above is realized through the cooperation of software, and the hardware of the wearable device 1 described below.

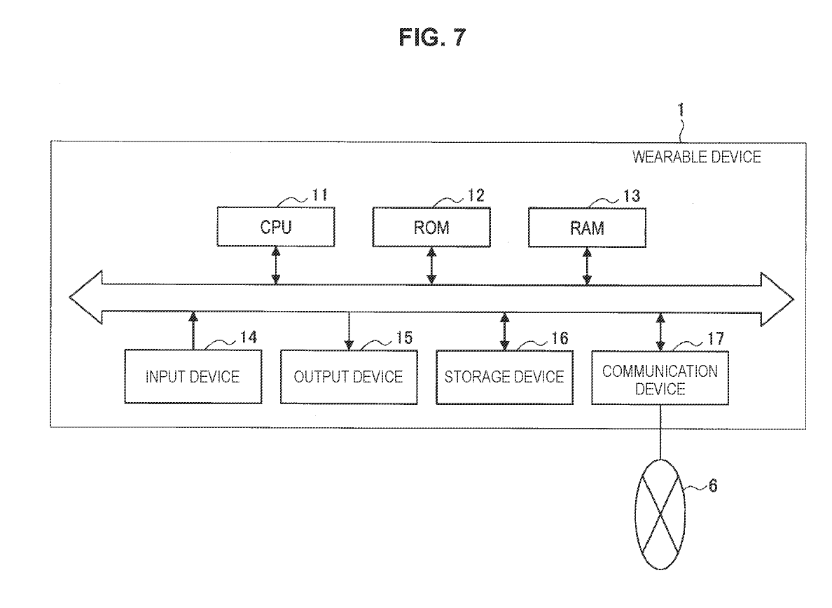

FIG. 7 is an explanatory diagram illustrating a hardware configuration of the wearable device 1. As shown in FIG. 7, the wearable device 1 includes a central processing unit (CPU) 11, a read only memory (ROM) 12, a random access memory (RAM) 13, an input device 14, an output device 15, a storage device 16, and a communication device 17.

The CPU 11 functions as an operation processing device and a control device, and controls the overall operation in the wearable device 1 in accordance with various programs. The CPU 11 may also be a microprocessor. The ROM 12 stores programs, operation parameters and the like used by the CPU 11. The RAM 13 temporarily stores programs used in the execution by the CPU 11, parameters that change appropriately in that execution, and the like. These are connected together by a host bus including a CPU bus or the like. The functions of the situation acquiring unit 104, the input/output method specifying unit 108, and the control unit 110 are realized mainly through software working in cooperation with the CPU 11, the ROM 12, and the RAM 13.

The input device 14 includes inputting means such as a mouse, a keyboard, a touch panel, a button, a microphone, a switch, and a lever, for the user to input information, an input control circuit that generates an input signal on the basis of input by the user, and outputs the generated input signal to the CPU 11, and the like. The user of the wearable device 1 is able to input various kinds of data and direct processing operations with respect to the wearable device 1, by operating the input device 14. The input device 14 corresponds to the input unit 112 described with reference to FIG. 2.

The output device 15 includes a display device such as a liquid crystal display (LCD) device, an OLED device, and a lamp, for example. Furthermore, the output device 15 includes a voice output device such as a speaker and headphones. For example, the display device displays a captured image, a generated image or the like. On the other hand, the voice output device converts voice data and the like into voice, and then outputs the voice. The output device 15 corresponds to the output unit 114 described with reference to FIG. 2.

The storage device 16 is a device for storing data. The storage device 16 may include a storage medium, a recording device that stores data in a storage medium, a readout device that reads out data from a storage medium, a deletion device that deletes data recorded in a storage medium, and the like. The storage device 16 stores programs executed by the CPU 11 and various kinds of data.

The communication device 17 is a communication interface including a communication device for connecting to the communication network 6, or the like, for example. Also, the communication device 17 may be a wireless local area network (LAN) compatible communication device, a long term evolution (LTE) compliant communication device, a wired communication device that performs communication via a wire, or a Bluetooth communication device. The communication device 17 corresponds to the communication unit 106 described with reference to FIG. 2.

Note that the hardware configuration of the wearable device 1 is described above, but the server 4 described with reference to FIG. 1 includes hardware corresponding to the CP 11, the ROM 12, the RAM 13 and the like, similarly to the wearable device 1.

### 7. CONCLUSION

As described above, according to the embodiment of the present disclosure, an input method or an output method for a wider variety of situations is able to be specified, by performing specification of an input/output method on the basis of situation information that is a combination of situation items in a plurality of situation categories. Also, the present technology is able to handle a wider variety of input/output methods, by performing the specification using an evaluation value set for each input/output method.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, in the embodiment described above, an example is described in which an eyeglasses-type wearable device is used as the information presenting terminal, but the present technology is not limited to this example. For example, the information presenting terminal may also be a smartphone, a tablet PC, an in-vehicle terminal or the like.

Also, in the embodiment described above, touch input, voice input, gaze input and the like are given as examples of the input method, but the present technology is not limited to this example. For example, input by a gesture performed at a distance not touching (contacting) the device, input by brainwaves or the like, may also be used as the input method. Also, the output method is similarly not limited to the example described above. Output by electrical stimulation or the like may also be used as the output method.

Also, in the embodiment described above, an example is described in which an input/output method specifying unit included in a device (a wearable device) that causes an application to be executed performs specification of the input/output method, but the present technology is not limited to this example. For example, specification of the input/output method may be performed by the device, or by another information processing device (such as the server 4 described with reference to FIG. 1, for example), and the specifying result may be transmitted to the device, and the input/output method may be changed.

Also, in the embodiment described above, an example is described in which a situation acquiring unit included in a device (wearable device) that causes an application to be executed acquires situation information by analyzing various kinds of data and generating situation information, but the present technology is not limited to this example. For example, the generation of the situation information by the analysis of data and the like may be performed by a different device than the device that performs specification of the input/output method based on the situation information. In this case, the device that acquires situation information by receiving (obtaining) the generated situation information, and performs specification of the input/output method on the basis of this situation information, corresponds to the information processing device according to the present technology.

Also, the respective steps in the embodiment described above do not necessarily have to be performed chronologically in the order illustrated in the flowchart. For example, the respective steps in the process of the embodiment described above may also be performed in a different order than the order illustrated in the flowchart, or they may be performed in parallel.

Also, a computer program for causing the hardware such as the CPU, ROM, RAM and the like built in the wearable device 1 and the server 4 to demonstrate the function of the wearable device 1 described above can also be created. Also, a storage medium that has the computer program stored therein is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

an acquiring unit that acquires situation information that is a combination of situation items in a plurality of situation categories; and

a specifying unit that perform specification of an input method or an output method of a user interface on a basis of the situation information.

(2)

The information processing device according to (1),

in which an evaluation value for each input method or each output method is set in advance for each situation item, and

the specifying unit further performs the specification on a basis of the evaluation value.

(3)

The information processing device according to (2),

in which the evaluation value is set such that the evaluation value of the input method or the output method that is more preferable is smaller, in the situation item related to the evaluation value, and

the specifying unit performs the specification by specifying the input method or the output method with a smallest total evaluation value that is obtained by adding up the evaluation values corresponding to the situation information.

(4)

The information processing device according to (2) or (3),

in which, in a case where the input method related to the evaluation value or the output method related to the evaluation value is unusable in the situation item related to the evaluation value, the evaluation value is set to a value indicating that the input method or the output method is unusable, and

the specifying unit performs the specification such that the input method or the output method that is unusable is not to be used.

(5)

The information processing device according to any one of (1) to (4),

in which the acquiring unit acquires the situation information by analysis based on sensing data.
(6)

The information processing device according to any one of (1) to (5),

in which the acquiring unit acquires the situation information by analysis based on personal data of a user.
(7)

The information processing device according to any one of (1) to (6),

in which the plurality of situation categories includes at least an environment.
(8)

The information processing device according to any one of (1) to (7),

in which the specifying unit performs the specification in a case where the situation information acquired by the acquiring unit is maintained for a predetermined period of time.
(9)

An information processing method including:

acquiring situation information that is a combination of situation items in a plurality of situation categories; and

causing a processor to perform specification of an input method or an output method of a user interface on a basis of the situation information.

(10)

A program for causing a computer to perform:

processing of acquiring situation information that is a combination of situation items in a plurality of situation categories; and

processing of performing specification of an input method or an output method of a user interface on a basis of the situation information.

### REFERENCE SIGNS LIST

1 wearable device
2 user
3 sensor device
4 server
5 touch device
6 communication network
102 sensor unit
104 situation acquiring unit
105 output device
106 communication unit
108 input/output method specifying unit
110 control unit
112 input unit
114 output unit
1000 information system

1. An information processing device comprising:
an acquiring unit that acquires situation information that is a combination of situation items in a plurality of situation categories; and
a specifying unit that perform specification of an input method or an output method of a user interface on a basis of the situation information.

2. The information processing device according to claim 1,
wherein an evaluation value for each input method or each output method is set in advance for each situation item, and
the specifying unit further performs the specification on a basis of the evaluation value.

3. The information processing device according to claim 2,
wherein the evaluation value is set such that the evaluation value of the input method or the output method that is more preferable is smaller, in the situation item related to the evaluation value, and
the specifying unit performs the specification by specifying the input method or the output method with a smallest total evaluation value that is obtained by adding up the evaluation values corresponding to the situation information.

4. The information processing device according to claim 2,
wherein, in a case where the input method related to the evaluation value or the output method related to the evaluation value is unusable in the situation item related to the evaluation value, the evaluation value is set to a value indicating that the input method or the output method is unusable, and
the specifying unit performs the specification such that the input method or the output method that is unusable is not to be used.

5. The information processing device according to claim 1,
wherein the situation information is generated on a basis of analysis of sensing data.

6. The information processing device according to claim 1,
wherein the situation information is generated on a basis of analysis of personal data of a user.

7. The information processing device according to claim 1,
wherein the plurality of situation categories includes at least an environment.

8. The information processing device according to claim 1,
wherein the specifying unit performs the specification in a case where the situation information acquired by the acquiring unit is maintained for a predetermined period of time.

9. An information processing method comprising:
acquiring situation information that is a combination of situation items in a plurality of situation categories; and
causing a processor to perform specification of an input method or an output method of a user interface on a basis of the situation information.

10. A program for causing a computer to perform:
processing of acquiring situation information that is a combination of situation items in a plurality of situation categories; and
processing of performing specification of an input method or an output method of a user interface on a basis of the situation information.
